(19) United States
(12) Patent Application Publication
(10) Pub. No.: US 2023/0375439 A1
(43) Pub. Date: Nov. 23, 2023

(54) METHOD AND SYSTEM FOR CHARACTERIZING A FOCUSING OPTICAL ELEMENT

(71) Applicant: Max-Planck-Gesellschaft zur Förderung der Wissenschaften e.V., München (DE)

(72) Inventors: Peter Banzer, Graz (AT); Jörg Eismann, Pinzberg (DE); Martin Neugebauer, Weißenburg (DE)

(21) Appl. No.: 18/362,170

(22) Filed: Jul. 31, 2023

Related U.S. Application Data
(63) Continuation of application No. PCT/EP21/53302, filed on Feb. 11, 2021.

(51) Int. Cl. G01M 11/02

(52) U.S. Cl. CPC G01M 11/0228

(57) ABSTRACT

A method for characterizing a focusing optical element comprises transmitting a light beam through the optical element such that the light beam is focused at a focal plane, collecting the light beam by a collection assembly, and detecting the light beam by an image detector. The method further comprises providing a scattering element between the optical element and the collection assembly such that the light beam generates a scattered reference wave, collecting the light beam and the reference wave, and detecting the light beam and the reference wave by the detector. The light beam and the reference wave partly overlap at the detector. Moreover, the method comprises determining an influence of the optical element on a wave front of the light beam based on the light beam and the reference wave. A system and a use of a system for characterizing a focusing optical element are further disclosed.

### CROSS REFERENCE TO RELATED APPLICATIONS

This application is a continuation application of international patent application PCT/EP2021/053392, filed on Feb. 11, 2021 and designating the U.S., which is hereby incorporated by reference.

### TECHNICAL FIELD

This disclosure relates generally to the field of optical elements and their characterization. More specifically, the disclosure relates to a method and a system for characterizing a focusing optical element and a method for characterizing a scattering element. The disclosure further relates to a use of a system for determining optical aberrations of the wave front of a light beam and/or for characterizing a microscope objective lens.

### BACKGROUND

For characterizing the wave front and/or optical aberrations of optical elements, such as microscope objective lenses, it is typically required to measure the wave front of an optical wave transmitted through the optical element under investigation. This is conventionally carried out by using interferometry or by using a particular type of sensor allowing to reconstruct the phase of the impinging optical wave, such as a Shack-Hartmann-Sensor (SHS). For this purpose, an incoming optical wave is typically transmitted through the optical element under test, which exhibits the aberrations of the optical element after propagating through the optical element.

Such measurements are comparative in nature, requiring a calibrated device acting as a benchmark to gain information about the object under test (see for instance P. Török et al., Optical Imaging and Microscopy, 2^{nd} ed., Springer-Verlag, Berlin Heidelberg, Cambridge, 2007). Providing such a calibrated reference can be rather challenging, especially in the realm of modern technologies and methods demanding miniaturization and increasing resolution. A ubiquitous example is the measurement of optical elements based on the phase front of the transmitted light field. Usually this is done by interferometry, where a well-characterized optical reference element, e.g., a flat mirror or a beam splitter, is utilized to create a reference wave. Consequently, the quality of this element sets an upper limit for the measurement accuracy because its defects translate directly into aberrations of the reference wave. Accordingly, having a reference optical element free of any aberrations is desirable, which, however, represents an ideal situation that is hard to achieve. Moreover, such a requirement merely transfers the problem of finding a way to characterize the optical aberrations of said reference optical element. Since also for this relative characterization a respective reference optical element is required, the problem remains unsolved.

### SUMMARY

It is, thus, desired to provide a method and a system for an absolute characterization of wave fronts of optical waves and/or optical elements without the need of an ideally aberration-free reference optical element.

This problem is solved by the methods, systems and uses having the features of the respective independent claims. Optional examples are presented in the dependent claims and the description.

### DESCRIPTION OF EXAMPLE METHODS AND SYSTEMS

One example according to the disclosure relates to a method for characterizing a focusing optical element. The method comprises transmitting a light beam through the focusing optical element such that the light beam is focused at a focal plane by the focusing optical element and collecting the focused light beam after the focal plane by a beam collection assembly and detecting the collected light beam by an image detector. The method further comprises providing a scattering element between the focusing optical element and the beam collection assembly such that the light beam generates a scattered reference wave. The method comprises in addition collecting the focused light beam and at least a part of the scattered reference wave after the focal plane by the beam collection assembly and detecting the collected light beam and the collected reference wave by the image detector, wherein the detected light beam and the detected scattered reference wave partly overlap with each other at the image detector. Moreover, the method comprises determining an influence of the focusing optical element on a wave front of the transmitted light beam based on the detected light beam and the detected scattered reference wave.

Another example of the disclosure relates to a system for characterizing a focusing optical element. The system comprises a beam collection assembly for collecting a light beam transmitted through and focused at a focal plane by the focusing optical element to be characterized, wherein the beam collection assembly is adapted to collect the focused light beam after the focal plane. The system further comprises a scattering element, wherein the scattering element is arrangeable in the light beam between the focusing optical element and the beam collection assembly such that the light beam generates a scattered reference wave and wherein the scattering element is removable from the light beam. Moreover, the system comprises an image detector for detecting the collected light beam and at least a part of the optionally generated scattered reference wave, wherein the detected scattered reference wave and the light beam partly overlap with each other at the image detector. The system further comprises a computing unit which is adapted to determine an influence of the focusing optical element on a wave front of the transmitted light beam based on the detected light beam and the detected partly overlapping scattered reference wave.

Yet another example relates to a use of a system according to the disclosure for determining optical aberrations of the wave front of the light beam caused by the focusing optical element to be characterized when transmitting the light beam through the focusing element.

Yet another example relates to a use of a system according to the disclosure for characterizing a microscope objective lens.

Yet another example relates to a method for characterizing a scattering element. The method comprises transmitting a light beam through a focusing optical element such that the light beam is focused at a focal plane by the focusing optical element. The method further comprises collecting the focused light beam after the focal plane by a beam collection assembly and detecting the collected light beam by an image detector. The method further comprises providing the scattering element to be characterized between the focusing optical element and the beam collection assembly such that the light beam generates a scattered sample wave. Moreover, the method comprises collecting the focused light beam and at least a part of the scattered sample wave after the focal plane by the beam collection assembly and detecting the collected light beam and the collected sample wave by the image detector. The method further comprises determining an influence of the scattering element arranged in the light beam on a wave front of the transmitted light beam based on the detected light beam and the detected scattered sample wave.

A focusing optical element is an optical element, such as a lens or microscope objective lens, having a refractive and/or diffractive power. The focusing optical element has a focusing or defocusing effect on an optical wave transmitted through the optical element. This focusing element has a focus in a focal plane being outside of the optical element, such that the focal plane is accessible at the outside of the optical element. The optical element may for instance consist of one single lens or minor or may comprise a plurality of lenses and/or minors. In an optional embodiment, the optical element may be an objective lens comprising an assembly of several lenses or other types of optical elements. Without limiting the disclosure, the objective lens may be an objective lens for a microscope and/or for photography and/or for a video camera.

The terms optical wave, light wave, light beam, and optical beam are used as synonyms throughout this text, unless explicitly stated otherwise. The wave front is regarded as the phase front of the optical wave, i.e., the spatial distribution of the light wave's phase over the transversal profile of the light wave.

Collecting the focused light beam according to the description may include collimating the divergent light beam after the focus. Collecting the light beam may further comprise controlling the size of the light beam and/or imaging the light beam to a desired plane for further use. Accordingly, the beam collection assembly may comprise one or more optical elements for collimating and/or reshaping and/or imaging the light beam, such as a collimating optical element. The beam collection assembly may consist of a single optical element or may comprise a plurality of optical elements. According to an example of the disclosure, the method comprises collecting the focused light beam without a scattering element and also collecting the focused light beam together with the scattered reference wave generated by the scattering element. In the latter case, the light beam and the scattered reference wave are collected simultaneously.

The image detector is a detector for detecting the light beam. The light beam may be imaged to the image detector, although such an imaging is not necessarily required. The image detector may be adapted to detect a spatial (transversal) intensity distribution of the light beam and optionally of an interference of the light beam with the scattered reference wave. For instance, the image detector may comprise a one-dimensional and/or a two-dimensional array of detector elements, such as a CCD array and/or a CMOS array. Without limiting the disclosure, the image detector may be adapted as a camera, in particular a digital camera. The image detector by itself is not required to retrieve any information regarding the phase of the wave front or parts of the wave front. Accordingly, it is not required to provide the image sensor as an SHS. Alternatively, or additionally the image detector is not required to provide any information regarding the polarization type and/or direction of the detected light beam. Instead, it may be sufficient for the image detector to detect the spatial intensity distribution of the light beam and the optionally interfering scattered reference wave.

A scattering element is an element provoking scattering of at least a part of the light beam when irradiated by the light beam. The scattering ability of the scattering element may be most efficient when placing the scattering element at the position where the light beam has a high intensity, such as in the focus of the light beam. The scattering element may be adapted to have a particularly high scattering cross section at the central wavelength of light beam. The scattering element may be adapted to the light beam with respect to its size and/or shape and/or material characteristics. The scattering element may consist of or comprise a nanoparticle, in particular a silicon nanoparticle and/or a metal nanoparticle.

The scattered reference wave is an optical wave generated by the scattering element due to scattering of at least a part of the light beam. Being a reference wave means that the scattered reference wave is used as a reference with respect to the optical wave or light beam transmitted through the focusing optical element under test.

The detected light beam and the scattered reference wave partly overlapping with each other at the image detector means, that the detected light beam and the scattered reference wave are at least partly detected by the image detector, wherein a part of the image solely relates to the scattered reference wave without the light beam overlapping it, and wherein other parts of the detected image relate to the scattered reference wave and the light beam overlapping each other and interfering with each other.

The invention provides the advantage that methods and systems for characterizing a focusing optical element can be provided circumventing the need for an aberration-free optical element. In other words, when using the invention, it is not required to use a reference optical element having no or only well-known optical aberrations for characterizing a focusing optical element under test. Therefore, major limitations for characterizing focusing optical elements are set aside, since there is no need of providing an aberration-free or extremely well-characterized reference optical element. This is in particular achieved by using the scattering element between the focusing optical element in the beam collection assembly. The scattering element provides the required reference wave, which is used as a reference to be compared with the light beam carrying the aberrations of the focusing optical element under test. Since the scattering element is provided only after the focusing optical element on the investigation, the generated scattered reference wave is not transmitted through the focusing optical element under test and, thus, does not exhibit the aberrations of the focusing optical element under test. Instead, the scattered reference wave generated by the scattering element scattering a part of the light beam allows generating a well-defined reference wave, which may be adapted to the specific individual needs by selectively choosing and adapting the used scattering element to the requirements and purposes of the measurement. Moreover, the scattered reference wave is being collected by the beam collection assembly in the very same manner as the light beam transmitted through the focusing optical element under test. This ensures that possible aberrations imposed onto the light beam when transmitted through the beam collection assembly are likewise imposed onto the scattered reference wave and therefore are canceled out when determining the influence of the focusing optical element on the wave front of the transmitted light beam. Hence, only those aberrations of the light beam, which are imposed onto the light beam by the focusing optical element affect the relative comparison of the light beam with the scattered reference wave, since all the possible aberrations affect the scattered reference wave in the light beam in the same manner and, thus, are canceled out or maybe separated during the evaluation.

In addition, the disclosure provides the advantage that no phase-sensitive detector, such as Shack-Hartmann-sensor (SHS) is required for characterizing the focusing optical element and its aberrations imposed on to the transmitted light beam. Accordingly, the system requirements, the complexity and/or the costs of such a system for characterizing focusing optical element may be kept at a low level. This facilitates manufacturing and/or use and allows its application in cost sensitive applications.

Moreover, the disclosure provides the advantage that the generated scattered reference wave may be adapted and/or optimized to the individual requirements of each measurement and/or focusing optical element to be characterized. Such an adaptation and/or optimization may be realized by varying the scattering element. For example, a scattering element may be varied with respect to its size and shape and/or material composition to have a desired scattering cross section and/or a desired emission of specific multipole orders of the scattered reference wave for the intended use.

In addition, examples according to the disclosure provide the advantage that the method and system may be used with a well-known and well-characterized focusing optical element to characterize an unknown scattering element. Characterizing a scattering element in this context means that one or more parameters of the scattering element are determined. However, the characterization of the scattering element does not necessarily mean a formal characterization of all physical parameters of the scattering element under test, such as a nanoparticle. For this purpose, the generated scattered wave may be used as a scattered sample wave to characterize the scattering element. In particular, the method may allow determining the far-field emission of the scattered wave generated by the scattering element and the light beam. It may thus provide information about the multipole orders of the generated scattered wave and consequently about the size and/or shape and/or material composition of the scattering element under investigation. The scattering element to be characterized may be a nanoparticle.

According to an optional example the scattering element is consecutively placed at different transversal positions of the light beam, wherein the collected light beam and at least the part of the scattered reference wave is detected for each transversal position of the scattering element. This allows generating different scattered reference waves due to the different transversal positions of the scattering element. Moreover, the scattering efficiency can be varied by varying the transversal position of the scattering element with respect to the focal axis.

According to an optional example, the scattering element is arranged within an accessible focal volume. According to a further optional example, the scattering element may be arranged within a longitudinal distance from the focal plane being equal to or less than the Rayleigh range of the focused light beam. According to yet another optional example, the scattering element is arranged in the focal plane or within a longitudinal distance of ±2 mm from the focal plane. The smaller the longitudinal distance of the scattering element from the focal plane, the higher the intensity of the focused beam may be, which is experienced by the scattering element, if the scattering element is arranged at the optical axis of the focused light beam. The higher the local intensity experienced by the scattering element, the higher the scattering will be and consequently the higher the power of the generated scattered reference wave will be. Typically, for many beam profiles the intensity is the highest at the focal point of the system. Therefore, according to an optional example, the scattering element may be arranged in or close to the focal point. Optionally, the scattering element is arranged with a longitudinal distance of not more than 1 μm from the focal plane. This ensures a high scattering strength and, thus, a strong scattering wave generated by the scattering element which allows achieving a high signal-to-noise ratio.

According to an optional example, the scattering element is adapted such that the reference wave generated by the light beam essentially consists of predetermined orders of electric and/or magnetic multipole radiation. This facilitates determining and/or estimating and/or fitting the scattered reference wave detected by the image detector. Since determining and/or estimating and/or fitting the scattered reference wave may include reconstructing the wave front of the scattered reference wave by means of calculations, good knowledge of or justified assumptions about the electric and/or magnetic multipole radiation, of which the scattered reference wave consists of, may facilitate the reconstruction process. Consequently, this facilitates determining the influence of the focusing optical element on the wave front of the transmitted light based on the detected light beam in the detected scattered reference wave. The scattering element may be adapted with regard to its size and/or shape and/or material properties to generate a scattered reference wave essentially consisting of predetermined orders of electric and/or magnetic multipole radiation.

Optionally, the scattering element is adapted such that the reference wave generated by the light beam essentially corresponds to electric dipole radiation and optionally electric quadrupole radiation and optionally magnetic dipole and/or quadrupole radiation. Restricting the reference wave to said orders facilitates its reconstruction, in particular by fitting the reference wave by means of calculations.

According to an optional example, several different scattering elements are used in consecutive measurements for generating the reference wave. This allows generating several different scattered reference waves for consecutive measurements. Optionally said differences between the reference waves essentially correspond to different electric and/or magnetic multipole radiation patterns. Therefore, using several different scattered reference waves in consecutive measurements may allow retrieving an influence of the focusing optical element on the wave front of the transmitted light beam in a more reliable manner. In particular, the influence of possible deviations of the reconstructed and/or fitted scattered reference wave from the actual wave front of the scattered reference wave may be reduced when using several different scattered reference waves in consecutive measurements.

According to an optional example, collecting the focused light beam and optionally at least the part of the scattered reference wave comprises collimating the light beam and optionally imaging the light beam to the image detector. This may allow for collecting all or most of the focused light beam and the scattered reference wave and providing them to the image detector. Accordingly, a high signal to noise ratio may be achieved. The beam collection assembly may comprise a collimating optical element and optionally one or more imaging optical elements. According to an optional example, the collimating optical element is a microscope objective lens and optionally an immersion type microscope objective lens. According to a further optional example, the collimating optical element may be of the same or a similar type as the focusing optical element on the investigation. For instance, the focusing optical element under investigation and the collimating optical element may both have large numerical apertures. For example, the focusing optical element may be a dry microscope objective lens having a numerical aperture of 0.9, while the collimating optical element may be an immersion type objective lens having a numerical aperture of 1.32. The collimating optical element having a larger numerical aperture than the focusing optical element may ensure providing a second region of the detected image, in which the detected scattered reference wave is not overlapped by the collimated light beam transmitted through the focusing optical element under test.

According to an optional example, the light beam is provided with a predetermined polarization. Optionally the light beam is provided in consecutive measurements with different predetermined polarizations. This allows retrieving additional information with regard to the influence of the focusing optical element on the polarization of the transmitted light beam. Moreover, this may allow retrieving additional information with respect to the polarization when using a scattering element generating a scattered reference wave having an isotropic behavior with regard to the polarization of the generated scattered reference wave.

According to an optional example, collecting and detecting the focused light beam and at least a part of the scattered reference wave is carried out such that a first region of an image detected by the image detector corresponds to an overlap of the light beam and the reference wave and a second region of the image detected by the image detector essentially corresponds only to a part of the reference wave. This allows a clear separation of different areas of the detected signal, in which the scattered reference wave and the light beam are overlapping and in which solely the scattered reference wave generates the detector signal, respectively. Accordingly, the second region of the image detected by the image detector may serve the purpose of characterizing and/or determining and/or reconstructing and/or fitting the scattered reference wave, i.e., the intensity distribution and/or phase distribution of the scattered reference wave over its profile. The first region of the image detected by the image detector may then serve the purpose of determining the influence of the focusing optical element on the transmitted light beam interfering in the first region of the image with the reconstructed and/or fitted scattered reference wave. Determining the influence of the focusing optical element on the wave front of the transmitted light beam may include determining an intensity distribution of the first part of the image detected by the image detector and determining an intensity distribution of the second part of the image detected by the image detector. The method may further include fitting a calculated far-field emission of multipole radiation to an intensity distribution of the second region of the image detected by the image detector for characterizing the reference wave. Therefore, this scattered reference wave, i.e., its far-field emission may be reconstructed based on the second region of the image and the influence of the focusing optical element on the transmitted light beam may be determined on the first region of the image. Thus, the reconstruction and/or fitting of the scattered reference wave and its far-field emission can be based on a part of the image detected by the image detector, which is not influenced by the focusing optical element, its aberrations, and the transmitted light beam and, thus, possibly undesired influences can be avoided. This leads to a high reliability and robustness of the method for characterizing the aberrations of the focusing optical element.

According to an optional example, the scattering element comprises or consists of a nanoparticle, wherein the nanoparticle is optionally supported by a transparent substrate. The scattering element may be selected to be suitable for the (central) wavelength of the light beam used for the characterization method and/or to be adapted to the fitting process for retrieving the intensity and/or phase distribution of the scattered reference wave. In particular, the scattering element may be chosen such as to have a suitable and optionally large scattering cross section at the wavelength of the light beam used for the measurement and may be chosen such as to have a far-field emission of scattered light comprising or consisting of predetermined and known multipole orders, in particular predetermined and known low multipole orders, such as dipole and quadrupole modes.

In other words, the particle optionally supports only very few multipole orders. This reduces the number of free parameters required for the retrieval and fitting of the intensity and phase distribution of the scattered reference wave. Consequently, this improves the reliability and accuracy of the method. The number of multipole orders comprised by the far-field emission may be reduced by reducing the size and/or changing the shape of the scattering element.

Furthermore, the scattering element optionally has a large scattering cross section, which may be chosen as large as possible. This improves the signal-to-noise ratio and, thus, the accuracy of the characterization method. This is due to the reconstruction of the phase of the light beam being based on the interference between the light beam and the scattered reference wave. The scattering cross section can be increased by increasing the size of the scattering element. Since this requirement contradicts the previous requirement regarding the multiple orders, a compromise may have to be found. Therefore, the size of the particle should be chosen large enough to exhibit a sufficient scattering cross section and at the same time small enough to limit the far field emission to only a few multipole orders.

A further parameter for optimizing the scattering cross section may be the material composition of the scattering element. Typically, nanoparticles may be a suitable choice for the scattering element. For example, gold nanoparticles, which may have a spherical shape and a radius between 40 and 70 nm may be a suitable choice for measurements with a light beam having a wavelength in the range of 500 to 700 nm. Such spherical gold nanoparticles may be advantageous, since they mostly support electric dipole radiation.

Another suitable choice for scattering elements may be silicon nanoparticles, due to their suitability for a very broad wavelength range, since their resonance wavelength may be tuned over a wide range by varying the radius of the spherical silicon nanoparticles. Although silicon nanoparticles support the emission of magnetic dipole radiation in addition to electric dipole radiation, such particles may be a suitable choice due to their typically larger scattering cross section as compared gold nanoparticles. For the sake of providing an example, a spherical silicon nanoparticle having a radius of 70 to 80 nm may be well suited for measurements in the wavelength range of 500 to 750 nm. A spherical silicon nanoparticle having a radius of 200 nm may be a suitable choice for measurements in the wavelength range of 1.250 to 2.000 nm.

One or more scattering elements, such as nanoparticles, may be provided on a glass slide or glass substrate allowing a convenient positioning of the scattering element in the focus of the light beam. Needless to say, that the glasslike or any other used substrate has to be transparent for the light beam. For instance, the one or more scattering elements may be provided on the glass slide by a lithographic process. Optionally, several different or identical scattering elements may be provided on a substrate. A large number of scattering elements provided on the substrate may facilitate the arrangement of one scattering element in the focus, since it is not necessary to arrange one particular scattering element into focus. However, the several scattering elements should have a sufficiently large distance between each other, such that only one scattering element may be arranged in the focus at a time without any one of the other scattering elements interfering with the light beam. According to an optional example, several scattering elements are provided on the substrate forming a regular arrangement, such as a grid, which may facilitate arranging one of the scattering elements in the focus. Such grids or any other arrangements of several scattering elements in the substrate may be provided in a lithographic process. Moreover, a substrate may comprise various different scattering elements, which may differ with regard to their scattering cross section and/or their resonance wavelengths and/or their multipole orders of their far field emission.

It is understood by a person skilled in the art that the above-described features and the features in the following description and figures are not only disclosed in the explicitly disclosed examples and combinations, but that also other technically feasible combinations as well as the isolated features are comprised by the disclosure. In the following, several preferred examples of the disclosure and specific examples of the disclosure are described with reference to the figures for illustrating the disclosure without limiting the disclosure to the described examples.

### BRIEF DESCRIPTION OF THE DRAWINGS

Further optional examples will be illustrated in the following with reference to the drawings.

FIG. 1 depicts a system for characterizing a focusing optical element according to an optional example of the disclosure.

FIGS. 2A and 2B show intensity profiles taken according to a method according to an optional example.

FIG. 3 depicts images taken according to a method according to an optional example together with the reconstruction of the phase distribution of the light beam.

In the drawings the same reference labels are used for corresponding or similar features in different drawings.

### DESCRIPTION OF EXEMPLARY EMBODIMENTS

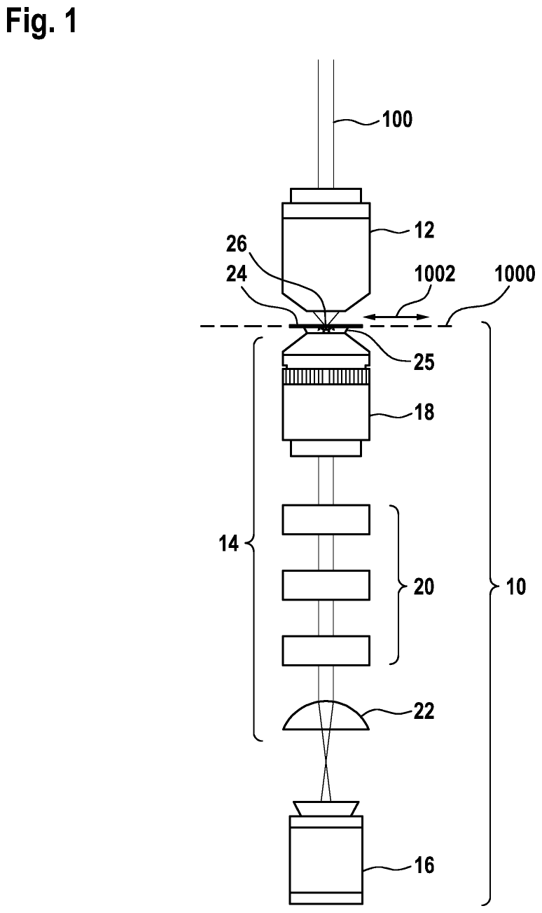

FIG. 1 depicts a system 10 according to an optional example for characterizing a focusing optical element 12. The focusing optical element 12 interacts with the system 10 but does not form part of the system 10.

The system 10 serves the purpose of characterizing the focusing optical element 12 with respect to possible aberrations imposed on the light beam 100 transmitted through the focusing optical element 12. According to the present example the focusing optical element 12 is a microscope objective lens. The focusing optical element 12 under test focuses a light beam 100 coupled into the focusing optical element 12 into a focal plane 1000.

The system 10 comprises a beam collection assembly 14 for collecting and collimating the divergent and previously focused light beam 100 and transmitting the light beam 100 to an image detector 16 forming part of the system 10. According to the presented example the beam collection assembly 14 comprises several further optical elements, wherein one of these optical elements is a collimating element 18 for fully or partly collimating the divergent light beam 100 after the focus in the focal plane 1000. The beam collection assembly 14 according to the presented example further comprises additional optional optical elements 20 for an optional polarization analysis of the light beam 100, such as liquid crystal variable retarders and a linear polarizer. The beam collection assembly 14 finally comprises an imaging lens 22 for imaging the back focal plane of the collecting optical element 18 to the image detector 16 to retrieve the angular distribution of the collected signal.

According to the presented example the image detector 16 is adapted as a digital camera having a two-dimensional array of sensor pixels for detecting a spatial intensity distribution.

Moreover, the system 10 comprises a scattering element 24 arranged between the focusing optical element 12 and the beam collection assembly 14 in the focal plane 1000 or close to it. According to the preferred example the scattering element 24 comprises a nanoparticle, which generates a scattered reference wave 26 when irradiated with the focused light beam 100. As indicated in FIG. 1, the scattering element 24 may be supported by a transparent slide, such as a glass slide, which allows arranging the scattering element 24 at the desired position in the focal plane 1000 and optionally directly in the focus or adjacent to it to generate a scattered reference wave 26. The reference label 24 indicates the supporting transparent slide, since individual nanoparticles forming the actual scattering elements 24 are too small to be presented in this schematic sketch. The space between the glass slide and the collecting optical element may be filled with an immersion oil 25.

Scattered reference wave is indicated in the figure by the area marked with a reference label 26. This scattered reference wave 26 extends from the scattering element 24 arranged in or close to the focus of focal plane of the light beam 100 and is at least partly collected and collimated by the collimating optical element 18 of the beam collection assembly 14. Accordingly, when the scattering element 24 is arranged in the light beam 100, in particular in the focus of the light beam 100, this scattered reference wave 26 is generated and transmitted through the beam collection assembly 14 together with the collected and collimated light beam 100. It is to be noted that this scattered reference wave 26 is generated only in the focus after the focusing optical element 12 under test and therefore is not subject to possible optical aberrations of the focusing optical element 12 under test.

According to the presented example the collimating optical element 18 has a higher numerical aperture than the focusing optical element 12 under test. This allows for collecting and collimating parts of the scattered reference wave 26 having a larger divergence than the divergent light beam 100 after the focus. The beam collection assembly 14 and the image detector 16 are adapted to image the transmitted light beam 100 and the overlapping scattered reference wave 26 to a first region of the image detected by the image detector 16 and in addition image and additional part of the scattered reference wave 26 to a second region of the image detector 16 not overlapping with the light beam 100. Said part of the scattered reference wave 26 imaged to the second region of the detected image may be that part of the scattered reference wave 26 collected and collimated by the outer area of the collimating optical element 18 exceeding the numerical aperture of the focusing optical element 12 under test. Accordingly, the larger the difference between the numerical apertures of the collimating optical element 18 in the focusing optical element 14, the larger the second region of the detected image corresponding solely to the reference wave 26 is.

For characterizing the focusing optical element 12, images may be detected with and without the scattered reference wave 26 overlapping the detected light beam 100 on the detector 16. This may be achieved in consecutive measurements, wherein the measurement with the scattered reference wave 26 overlapping the light beam 100 may be carried out with the system 10 as described above, and therein the measurement of the light beam 100 without the scattered reference wave 26 overlapping may be carried out in a separate measurement with the scattering element 24 being removed from the focus and the light beam 100. This may be achieved for instance by moving the transparent slide carrying the scattering element 24 at least partly parallel to the focal plane to move the scattering element 24 out of the focus, as indicated by arrow 1002.

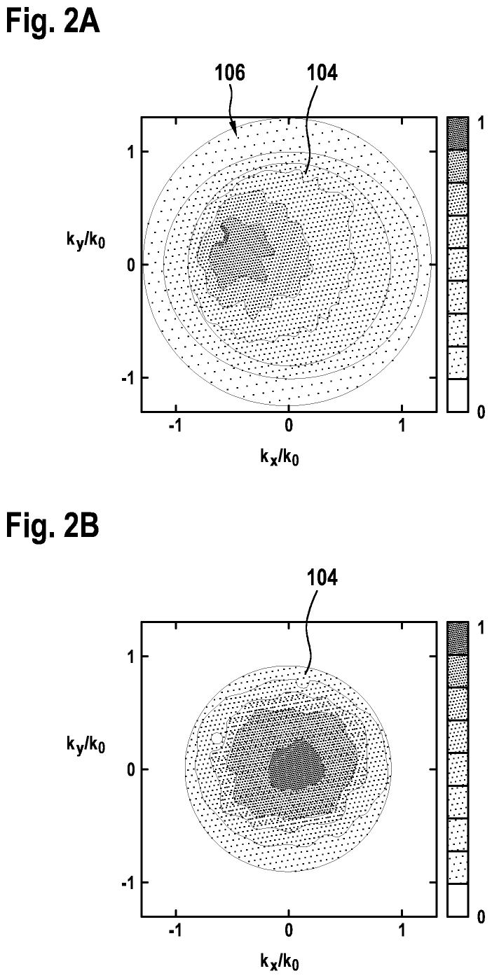

With reference to FIGS. 2A and 2B a method for characterizing a focusing optical element 12 according to an optional example is described. The method according to the presented example uses a system 10, as presented with reference to FIG. 1. The method uses a nanoparticle as a scattering element 24, which is placed in the focal plane of the focusing optical element 12 and the collimating optical element 18, which both share the same focal plane 1000. The scattering element 24 can be removed from the focus and/or the light beam 100 to carry out measurements without the scattering element 24 arranged in the focus and the light beam 100.

The method further comprises optional polarization measurements which are performed by controlling liquid crystals, which form part of the additional optical elements 20 of beam collection assembly 14. For example, various measurements may be carried out for linear polarization having polarization angles of 0°, 45°, 90° and 135°, as well as for left-and right-handed circular polarization.

For each of the polarizations an image is detected of the light beam 100 and the scattered reference wave 26 collected and collimated by the beam collection assembly 14 and imaged to the image detector 16. Afterwards the scattering element 24 is removed from the focus and the light beam 100 and the measurements are repeated. The order of carrying out the measurements may be changed or reversed.

The measurements and the changes of the system 10 between the individual measurements are carried out in an automated manner, i.e., the change of the polarization controlling optical elements and/or the removal or inserting of the scattering element into the focus are carried out in an automated manner.

FIG. 2A schematically illustrates the image detected by the image detector 16 for measurements when the scattering element 24 is placed in the focus of the light beam 100 and generates the scattered reference wave 26. The focusing optical element 12 under test is a microscope objective lens of the type LEICA HCX PL FLUOTAR 100x/0.9. The used collimating optical element 18 is a microscope objective lens of the type LEICA HCX FLUOTAR 100x/1.32 OIL. Accordingly, the detected image represents an intensity distribution of the light beam 100 and the scattered reference wave 26 at a detection plane of the image detector 16, which corresponds to an angular distribution of the light beam 100 and the reference wave 26 after the focus. The light beam 100 is a Gaussian beam having a central wavelength of 680 nm, a spectral width Δλ≈5 nm and a beam waist w₀=3 mm. The detected image comprises a first region 104 in the center of the detected image and a second region 106 surrounding the centered first region 104. The first region 104 corresponds to an intensity distribution, in which the light beam 100 and the scattered reference wave 26 are overlapping and interfering, which results in the intensity distribution of the first region 104. The second region 106 originates solely from the scattered reference wave 26, which has a larger divergence than the light beam 100 after the focus and therefore spreads around the central first region 104 in the detected image. As can be seen, the intensity of the light beam in the first region 104 exceeds the intensity of the scattered reference wave 26 in the second region by far.

However, the isolated image of the scattered reference wave 26 in the second region 106 allows fitting and/or reconstructing the whole profile of the scattered reference wave 26, as will be explained in detail further below.

The image in FIG. 2B shows the intensity distribution of the light beam 100 without an overlapping scattered reference wave 26. This image was taken with the scattering element 24 removed from the focus and the light beam 100 such that no scattered reference wave is generated. This allows detecting solely the light beam 100 with the image detector without an overlapping reference wave.

In the following, a retrieval of the phase front of the light beam 100 and the determination of the influence of the focusing optical element on a wave front of the transmitted light beam according to an optional example are described.

When measuring with the scattering element 24 in the focused light beam 100, the first region 104 of the intensity profile shows the interference between the transmitted light beam 100 and the scattered reference wave 26 generated by the scattering element 24. When the scattering element 24 is not placed in the focus and the light beam 100, the intensity profile of the light beam 100 is measured without the scattered reference wave 26 overlapping.

For retrieving the phase front of the scattered reference wave 26 in the central first region 104, the far-field emission of dipoles is calculated for an emitter, i.e., a scattering element 24, placed on a glass substrate. Theoretical far-fields are fitted to the outer second region 106 of the detected image where only the scattered reference wave 26 is recorded. According to the presented optional example, for these fits, the amplitudes and phases of the multipole contributions, which are in the present case limited to dipole contributions, serve as free parameters. A full set of Stokes parameters may be measured before and provided in order to prevent ambiguities during the identification of the generated dipole moments. The distance of the scattering element 24 above the surface is determined by a fit as well. The distance of the scattering element 24 from the surface of the glass slide may correspond to the radius or half thickness of the scattering element 24. Once the fit has converged, the retrieved parameters can be used to calculate the emission of the excited dipole moments to the whole three-dimensional space. In our case, we are especially interested in calculating the emission in the central first region 104 of the detected image. Knowing the dipole moments allows calculating the far-fields also in the central first region, i.e., in the region covered by the numerical aperture of the focusing optical element 12 under test, where interference with the transmitted light beam 100 is observed.

At this point we now have the following information in the inner region of the detected image:

I₁, which indicates the intensity distribution of the transmitted light beam 100; I₂, which indicates the intensity distribution of the scattered reference wave 26;

Iₜₒₜ, which indicates the resulting intensity distribution of the interference of components I₁ and I₂.

Furthermore, the phase distribution of the scattered reference wave φ₂ is known, as the scattered light in the central first region 104 of the detected image was calculated from the fitted dipole moments and therefore contains full amplitude and phase information. Using the following standard equation for two interfering light fields

Iₜₒₜ=I₁+I₂+2\sqrt{I₁I₂}·cos(φ₁−φ₂)

we can see that the only unknown component in equation (1) is φ₁, which indicates the phase distribution of the light beam 100, which therefore can be calculated easily.

In other words, the exact information including intensity I₂ and phase φ₂ distributions of the scattered reference wave is used for the characterization of the focusing optical element 12.

It is emphasized that the focusing optical element 12 under test is the only optical element, through which the light beam 100 is transmitted but the scattered reference wave 26 is not transmitted. The light beam 100 and the scattered reference wave 26 are transmitted through all optical elements of the system 10 in an equal manner. This bears the significant advantage that possible aberrations, which are possibly caused by the optical elements of the system 10 equally affect the light beam 100 and the scattered reference wave 26. Thus, the only aberrations affecting the light beam 100 but not the scattered reference wave 26 essentially originate in the focusing optical element 12 under test. Consequently, the system 10 and method allow an undistorted characterization of the focusing optical element 12 under test. Therefore, the system is invariant to phase distortions of all other subsequent components in the system.

As a further optional step, the lowest order Zernike polynomials (piston, tip, tilt, defocus) may be fitted and subtracted from the calculated distributions, as these contributions are of minor importance for the characterization of the focusing optical element 12 under test. These contributions can be influenced and/or corrected by tilting and/or moving the focusing optical element 12 and therefore usually are not considered as an aberration caused by the focusing optical element 12.

The method for characterizing the focusing optical element 12 may be partly or fully automated. For instance, the method may be carried out by a computer program. The computer program may, for instance, be configured to include one or more of the following functionalities: controlling a piezo table for controlling the position of the scattering element 24, controlling a light source, recording data provided by the image detector 16 and/or possible further sensors; controlling a voltage applied to optional liquid crystal cells for polarization analysis; triggering the image detector 16.

The evaluation of the detected image may also be automatedly carried out by a computer program. For example, the computer program may be written with a conventional mathematical programing environment, such as MATLAB.

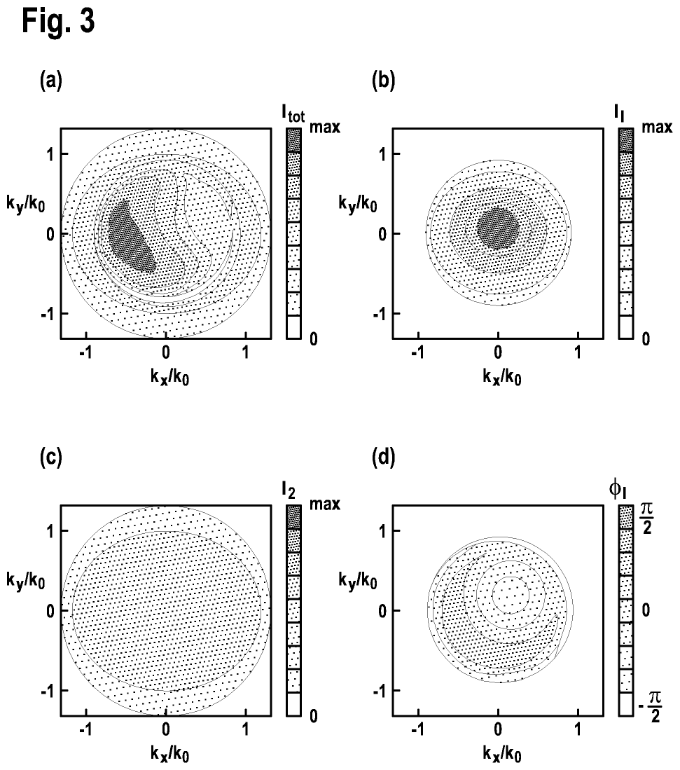

FIG. 3 exemplarily indicates detected images for the characterization of a microscope objective lens as the focusing optical element 12 under test. For the measurement, a laser beam having a central wavelength of 680 nm was selected as light beam 100. The scattering element 24 is provided as a spherical silicon nanoparticle having a radius of 76 nm attached to a glass slide. The sections of FIG. 3 depict the detected image of the intensity profile with the scattering element 24 placed in the focus of the light beam 100 (section a) and with the scattering element 24 removed from the focus and the light beam 100 (section b). Section c) indicates calculated emission pattern for the retrieved dipole moments, i.e., the retrieved intensity distribution of the scattered reference wave by calculation Section d) depicts the reconstructed phase distribution of the k-spectrum of the light beam 100 as focused by the microscope objective lens, which is the focusing optical element 12 under investigation. For illustrative purposes, the lowest order Zernike polynomials (Piston, Tip, Tilt, Defocus) are fitted and subtracted. Section d) clearly shows a crescent-shaped deformation of the phase front indicating the presence of aberrations induced by the microscope objective lens. This explains the corresponding distortion of the total intensity Iₜₒₜ as illustrated in section a), although the individual intensity distributions I₁ of the light beam 100 and I₂ of the scattered reference wave 26 look rather symmetric (see sections b) and c)).

According to the presented example, a nanoparticle was chosen as the scattering element 24 emitting a scattered wave essentially corresponding to a dipole far-field emission. However, according to other examples different scattering elements 24 may be chosen, which may comprise an emission including other multipole orders. The preferred multipole modes of the emission of the scattering element may be considered when fitting the intensity and/or phase distribution of the scattered reference wave 26. Selecting a scattering element 24 having a known and predetermined emission comprising or consisting of predetermined multipole orders may facilitate the fitting process and reduce ambiguities. Keeping the multipole orders low, i.e., restricted to dipole and optionally to quadrupole orders, may have the benefit of reducing the required computational effort for the fitting process.

It should be noted that this method is not restricted to the chosen wavelength. Although for a fixed nanostructure the potential spectral range may be limited, by using particles of other sizes, the available range can span the whole visible and near-infrared spectrum. Furthermore, it is also not necessary to use a perfectly spherical nanoparticle, since this procedure is capable of identifying arbitrary combinations of dipoles. As long as the scattering element features a reasonably strong dipole response and simultaneously suppresses higher order multipoles, it is possible to use almost arbitrarily shaped nanostructures. As an example, metal cylinders (e.g., made from gold etc.) may be used as an alternative to the spherical nanoparticles. Using modern lithography, cylindrical nanostructures can be fabricated easily in arrays including different sizes, hence providing a full range of different probes on a single sample to cover and measure over a wide spectral range.

### LIST OF REFERENCE LABELS

10 system for characterizing a focusing optical element
12 focusing optical element
14 beam collection assembly
16 image detector
18 collimating optical element
20 (optional) additional optical elements
22 imaging lens
24 scattering element (attached to glass slide)
25 immersion oil
26 scattered reference wave
100 light beam
104 first region of image
106 second region of image
1000 focal plane
1002 sliding direction for removal of scattering element

1. A method for characterizing a focusing optical element, the method comprising:
transmitting a light beam through the focusing optical element such that the light beam is focused at a focal plane by the focusing optical element;
collecting the focused light beam after the focal plane by a beam collection assembly and detecting the collected light beam by an image detector;
providing a scattering element comprising or consisting of a nanoparticle between the focusing optical element and the beam collection assembly such that the light beam generates a scattered reference wave;
collecting the focused light beam and at least a part of the scattered reference wave after the focal plane by the beam collection assembly and detecting the collected light beam and the collected reference wave by the image detector, wherein the detected light beam and the detected scattered reference wave partly overlap with each other at the image detector; and
determining an influence of the focusing optical element on a wave front of the transmitted light beam based on the detected light beam and the detected scattered reference wave.

2. The method according to claim 1, wherein the scattering element is consecutively placed at different transversal positions of the light beam and wherein the collected light beam and at least the part of the scattered reference wave are detected for each transversal position of the scattering element.

3. The method according to claim 1, wherein the scattering element is arranged in the focal plane or within a longitudinal distance of ±2 mm from the focal plane.

4. The method according to claim 1, wherein the scattering element is adapted such that the reference wave generated by the light beam essentially comprises predetermined orders of electric and/or magnetic multipole radiation.

5. The method according to claim 4, wherein the scattering element is adapted such that the reference wave generated by the light beam essentially corresponds to electric dipole radiation and optionally electric quadrupole radiation.

6. The method according to claim 1, wherein the nanoparticle has a far-field emission of scattered light comprising or consisting of a predetermined and known dipole mode and/or predetermined and known quadrupole mode.

7. The method according to claim 1, wherein several different scattering elements are used in consecutive measurements for generating the reference wave.

8. The method according to claim 1, wherein collecting the focused light beam and optionally at least the part of the scattered reference wave comprises collimating the light beam and optionally imaging the light beam to the image detector.

9. The method according to claim 1, wherein the light beam is provided with a predetermined polarization.

10. The method according to claim 1, wherein the light beam is provided in consecutive measurements with different predetermined polarizations.

11. The method according to claim 1, wherein collecting and detecting the focused light beam and at least the part of the scattered reference wave is carried out such that a first region of an image detected by the image detector corresponds to an overlap of the light beam and the reference wave and a second region of the image detected by the image detector essentially corresponds only to the part of the reference wave.

12. The method according to claim 11, wherein determining the influence of the focusing optical element on the wave front of the transmitted light beam includes determining an intensity distribution of the first part of the image detected by the image detector and determining an intensity distribution of the second part of the image detected by the image detector.

13. The method according to claim 12, further including fitting a calculated far-field emission of multipole radiation to an intensity distribution of the second region of the image detected by the image detector for characterizing the reference wave.

14. A system for characterizing a focusing optical element, the system comprising:
a beam collection assembly for collecting a light beam transmitted through and focused at a focal plane by the focusing optical element to be characterized, wherein the beam collection assembly is adapted to collect the focused light beam after the focal plane;
a scattering element comprising or consisting of a nanoparticle, wherein the scattering element is arrangeable in the light beam between the focusing optical element and the beam collection assembly such that the light beam generates a scattered reference wave and wherein the scattering element is removable from the light beam;
an image detector for detecting the collected light beam and at least a part of the generated scattered reference wave, wherein the detected scattered reference wave and the light beam partly overlap with each other at the image detector; and
a computing unit which is adapted to determine an influence of the focusing optical element on a wave front of the transmitted light beam based on the detected light beam and the detected partly overlapping scattered reference wave.

15. The system according to claim 14, wherein the beam collection assembly comprises a collimating optical element and optionally one or more imaging optical elements.

16. The system according to claim 15, wherein the collimating optical element is a microscope objective lens and optionally an immersion type microscope objective lens.

17. The system according to claim 15, wherein the collimating optical element is chosen to have a larger numerical aperture than the focusing optical element to be characterized.

18. The system according to claim 14, wherein the image detector corresponds to a camera.

19. The system according to claim 14, wherein the nanoparticle has a far-field emission of scattered light comprising or consisting of a predetermined and known dipole mode and/or a predetermined and known quadrupole mode.

20. A process of utilizing the system according to claim 14, the process comprising:
determining optical aberrations of a wave front of a light beam caused by a focusing optical element to be characterized when transmitting a light beam through the focusing element.

21. The process according to claim 14, wherein the focusing optical element to be characterized is a microscope objective lens.

22. A method for characterizing a scattering element, the method comprising:
transmitting a light beam through a focusing optical element such that the light beam is focused at a focal plane by the focusing optical element;
collecting the focused light beam after the focal plane by a beam collection assembly and detecting the collected light beam by an image detector;
providing the scattering element comprising or consisting of a nanoparticle to be characterized between the focusing optical element and the beam collection assembly such that the light beam generates a scattered sample wave;
collecting the focused light beam and at least a part of the scattered sample wave after the focal plane by the beam collection assembly and detecting the collected light beam and the collected sample wave by the image detector; and
determining an influence of the scattering element arranged in the light beam on a wave front of the transmitted light beam based on the detected light beam and the detected scattered sample wave.

23. The method according to claim 22, wherein the scattering element is consecutively arranged at different transversal positions of the light beam and wherein the collected light beam and at least the part of the scattered sample wave is detected for each transversal position of the scattering element.

24. The method according to claim 22, wherein the scattering element is arranged in the focal plane or within a longitudinal distance of ±2 mm from the focal plane.

25. The method according to claim 22, wherein the nanoparticle has a far-field emission of scattered light comprising or consisting of a predetermined and known dipole mode and/or a predetermined and known quadrupole mode.
